(19) United States
(12) Patent Application Publication
(10) Pub. No.: US 2026/0135496 A1
(43) Pub. Date: May 14, 2026

(54) DIELECTRIC ELASTOMER ACTUATORS AND METHODS OF MANUFACTURING THEREOF

(71) Applicant: President and Fellows of Harvard College, Cambridge, MA (US)

(72) Inventors: Andrew Cohen, Cambridge, MA (US); Matthias Kollosche, Cambridge, MA (US); Robert J. Wood, Cambridge, MA (US); David Clarke, Cambridge, MA (US)

(73) Assignee: President and Fellows of Harvard College, Cambridge, MA (US)

(21) Appl. No.: 18/996,908

(22) PCT Filed: Jul. 21, 2023
(86) PCT No.: PCT/US2023/028386

§ 371 Date: Jan. 17, 2025

Related U.S. Application Data
(60) Provisional application No. 63/391,277, filed on Jul. 21, 2022.

(51) Int. Cl. H02N 1/00; B32B 25/02; B32B 37/00

(52) U.S. Cl. CPC H02N 1/006; B32B 25/02; B32B 37/025; B32B 2264/1051; B32B 2307/204

(57) ABSTRACT

Dielectric elastomer actuators and methods of manufacturing thereof are generally described. The methods of manufacturing dielectric elastomer actuators comprise two independent steps: (1) depositing a conductive material on a plurality of portions of one or more carrier substrates to form a plurality of electrodes; and (2) transferring the plurality of electrodes to a plurality of elastomer layers to form dielectric elastomer actuators.

### STATEMENT REGARDING FEDERALLY SPONSORED RESEARCH OR DEVELOPMENT

This invention was made with government support under 2011754 and 1830291 awarded by National Science Foundation (NSF). The government has certain rights in this invention.

### CROSS-REFERENCE TO RELATED APPLICATIONS

This application claims the benefit under 35 U.S.C. § 119(e) of U.S. Provisional Application Ser. No. 63/391,277, filed on Jul. 21, 2022, entitled “DIELECTRIC ELASTOMER ACTUATORS AND METHODS OF MANUFACTURING THEREOF,” which is hereby incorporated herein by reference in its entirety.

### FIELD

Embodiments described herein generally relate to dielectric elastomer actuators and associated methods.

### BACKGROUND

Multilayer dielectric elastomer actuators have a wide range of potential applications.

### SUMMARY

Dielectric elastomer actuators and methods of manufacturing thereof are generally described.

According to an aspect of the present technology, a method of forming a dielectric elastomer actuator is described, comprising: depositing a conductive material on at least a first portion of a first carrier substrate to form a plurality of electrodes comprising a first electrode; and transferring at least a portion of the first electrode to a first surface of a first elastomer layer to form a first electrode layer on the first elastomer layer.

In some embodiments, a method of forming a dielectric elastomer actuator is provided. In certain embodiments, the method comprises depositing a conductive material on at least a first portion of a first carrier substrate to form at least a first electrode. In certain embodiments, the method comprises transferring at least a portion of the first electrode to a first surface of a first elastomer layer to form a first electrode layer on the first elastomer layer.

According to an aspect of the present technology, a method of forming a multilayer dielectric elastomer actuator is described, comprising: depositing a conductive material on a plurality of portions of one or more carrier substrates to form a plurality of electrodes; transferring the conductive material from at least two electrodes of the plurality of electrodes to a plurality of elastomer layers to form a plurality of stacks; and laminating at least two stacks of the plurality of stacks together to form the multilayer dielectric elastomer actuator.

Other advantages and novel features of the present teachings will become apparent from the following detailed description of various non-limiting embodiments when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Various aspects and non-limiting embodiments will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the present teachings.

FIGS. 1A-1 to 1C-3 show, according to some embodiments, a schematic diagram of an exemplary batch-spray and stamp-transfer process.

FIGS. 2A-2B show an exemplary deposition system, according to some embodiments.

FIGS. 3A-3D show, according to some embodiments, effects of an exemplary mechanical treatment on electrode topography and breakdown strength of the dielectric elastomer actuator (DEA).

FIGS. 4A-4E demonstrate an exemplary electrode stamp-transfer process with a set of breakdown test electrodes on a 30 μm P7670 film spin-coated onto an acrylic substrate and cured, according to some embodiments.

FIG. 4F shows an effect of transferring an electrode from carrier film to various elastomer substrates, according to some embodiments.

FIGS. 5A-5D show, according to some embodiments, a characterization of multilayered elastomer samples with and without CB layers under uniaxial tensile strain.

FIG. 6A shows an exemplary demonstration device, according to some embodiments.

FIG. 6B shows a comparison of speaker input and output spectrograms of the exemplary demonstration device of FIG. 6A, according to some embodiments.

FIG. 6C shows a side view of an exemplary device, according to some embodiments.

FIG. 6D shows three selected strain cycles of the device of FIG. 6C, according to some embodiments.

FIG. 7 shows, according to some embodiments, a schematic diagram of an exemplary process comprising: (i) spraying a conductive material on a plurality of portions of a masked carrier substrate to form a plurality of electrodes (left); and (ii) transferring the plurality of electrodes to an elastomer layer (right).

FIGS. 8A-8D show four steps of an exemplary roll-treatment method, according to some embodiments.

FIG. 9 is a flow chart showing an exemplary process for processing electrode(s) and transferring the electrode(s), according to some embodiments.

FIG. 10 shows, according to some embodiments, structuring and processing of deposited film(s).

### DETAILED DESCRIPTION

Aspects of the disclosure relate to soft transducer technologies, including at least dielectric elastomer actuators (DEAs), and methods of manufacturing thereof. According to some embodiments, a method of manufacturing a multilayer dielectric elastomer actuator (MDEA) comprises a first step of depositing a conductive material on a plurality of portions of one or more carrier substrates to form a plurality of electrodes. The electrodes may comprise a single electrode and/or multiple discrete electrodes, which may be within a same electrode layer created from a same stamp. An electrode layer may comprise a collection of conductive units. In some embodiments, the method of manufacturing an MDEA comprises a second step of transferring a first electrode of the plurality of electrodes to a first elastomer layer to form a first electrode layer on the first elastomer layer. In some embodiments, the method of manufacturing an MDEA further comprises a third step of depositing a second elastomer layer on the first electrode layer and a fourth step of transferring a second electrode of the plurality of electrodes to the second elastomer layer to form a second electrode layer on the second elastomer layer. The third and fourth steps may be repeated until a desired number of electrode and elastomer layers has been reached.

DEAs and dielectric elastomer sensors have a number of potentially useful applications, including compression garments, haptic interfaces, endoscopes, prostheses, and collaborative robots. MDEAs may be particularly desirable, as they may permit generation of large forces and displacements without excessively high voltages. Comprised of a plurality of stacked dielectric elastomer actuator layers, an MDEA's force and displacement output scales proportionally with the number of layers. In some cases, a single-layer DEA with the same output as an MDEA would require a membrane tens to hundreds of times thicker and thus a voltage tens to hundreds of times higher to maintain the driving electrical field. Thus, unlike single-layer DEAs, MDEAs can be arbitrarily scaled to meet application-specific force and displacement requirements without requiring changes to actuator design, materials, or drive electronics. However, existing MDEA manufacturing processes are associated with a number of drawbacks, including low throughput, small electrode sizes, high costs, spatial inhomogeneities in the electrodes, and a need for difficult, time-consuming tuning of a large number of process parameters for different elastomers. Therefore, the development and commercial implementation have been hindered by existing manufacturing processes, which are low-throughput, limited in area, and/or limited in the range of elastomers that can be used. Accordingly, the inventors have appreciated that improved processes for manufacturing multilayer dielectric elastomer actuators are needed.

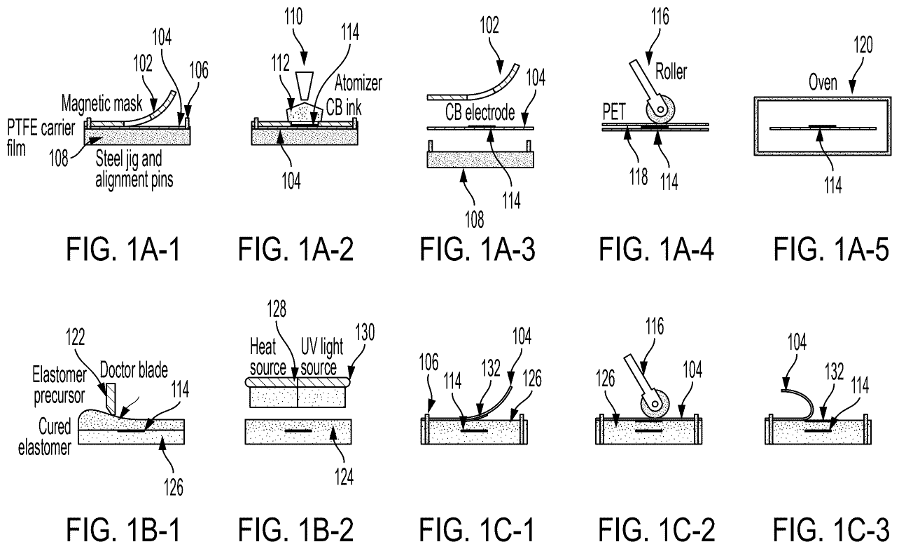

Some aspects of the present disclosure are directed to a method of forming an MDEA that overcomes these challenges. According to some embodiments, instead of sequentially patterning electrodes directly onto successive elastomer layers, a plurality of electrodes are deposited onto one or more carrier substrates in an independent deposition process, and the deposited electrodes are then transferred onto each elastomer layer (e.g., as shown in FIGS. 1A-1 to 1C-3 described further herein). In some cases, this modularizing of the production and assembly of electrodes may advantageously result in high throughput, large scalable electrode sizes, and/or tuning-free compatibility with a wide range of elastomers. In certain cases, the method may provide the unique capability to evaluate and modify electrodes before they are assembled into a multilayer stack. In some instances, the modified electrodes may exhibit enhanced properties, including but not limited to increased breakdown strength.

In some embodiments, a method of forming a DEA comprises depositing a conductive material on at least a first portion of a first carrier substrate to form a first electrode or film. The depositing of the conductive material may be performed using any deposition method known in the art. Non-limiting examples of suitable deposition methods include spraying (e.g., batch spraying), spray coating, ink jetting, Aerosol Jet printing, dip coating, roll-to-roll processes, stamping, doctor blading, electric spraying, screen printing, Langmuir-Blodgett deposition, vacuum filtration, chemical vapor deposition, and physical vapor deposition. In some embodiments, vacuum filtration may be the deposition method, and the substrate may be suitable for such a method, including but not limited to PTFE filters, such as from Advantec and/or Tisch.

In some embodiments, the conductive material comprises a carbon-containing conductive material, a metal-containing conductive material, a metal alloy, a conductive and semi conductive polymer, and/or any combination thereof. Examples of suitable carbon-containing conductive materials include, but are not limited to, carbon black (CB), graphite, graphene, and carbon nanotubes (CNTs, e.g., single-wall carbon nanotubes, multi-wall carbon nanotubes). Examples of suitable organic conductors include, but are not limited to, polyaniline (PANI) and poly(3,4-ethylenedioxythiophene) polystyrene sulfonate (PEDOT:PSS). Examples of suitable metal-containing conductive materials include, but are not limited to, 1D conductive nanoparticles, such as copper nanowires, silver nanowires (AgNWs) and gold nanoparticles.

Examples of suitable nanoparticles include, but are not limited to, metal nanostructures and metal particles, and nonconductive particle systems such as titanium dioxide (TiO₂), barium titanate (BaTiO₃), and silicon dioxide (SiO₂). Examples of suitable semi-conductive nanoparticles include, but are not limited to, semi-conductive nanowires, zinc oxide (ZnO), zinc sulfide (ZnS), cadmium sulfide (CdS), cadmium selenide (CdSe), cadmium telluride (CdTe), and quantum dots.

In some embodiments, conductive, semiconductive, and/or nonconductive particles and dielectrics may be used within stacks. As a non-limiting example, particles such as ZnO may be used, which in some embodiments, may act as switchable conductors.

In some embodiments, the non-limiting examples of suitable materials and particles for depositing can be mixed to enhance features including, but not limited to, durability.

In some embodiments, materials, such as, but not limited to, nanomaterials, may be mixed with adhesion promoters. An adhesion promoter may include urethanes such as polyurethane and/or room temperature vulcanizing (RTV) materials such as RTV silicone. The adhesion promoter may be added to the dispersed material or dispersed particles and may be added in low quantities, such as greater than 5 ppm, 10 ppm, or 100 ppm. The dispersed material may be dispersed in a suitable solvent, including but not limited to, isopropanol (IPA), organic solvents such as toluene, dimethyl sulfoxide (DMSO), Hexane, and/or chloroform, or mixtures thereof. An adhesion promoter, without wishing to be bound by theory, may act as a binder. An adhesion promoter may modify the adhesion strength of a deposited material. The deposited material may be dried and/or exposed prior to a curing step. A curing step may involve exposure to time, UV, or elevated temperatures. The curing may be performed through a mask as can spraying. The curing can increase adhesion strength. UV exposure can be used to alter adhesion locally and/or globally. In some embodiments, using an adhesion promoter allows for tuning the transfer step. Localized curing can allow for additional structuring of an electrode on a target substrate as only sections with overall low adhesion and interactions may transfer.

In some embodiments, the conductive material is deposited according to a pattern (e.g., the plurality of portions are arranged in a regular or irregular pattern). In certain embodiments, the method further comprises positioning or depositing a mask comprising a plurality of patterned openings on the first carrier substrate prior to the deposition of the conductive material. The mask be patterned according to known methods, such as but not limited to, vinyl cutting and/or laser cutting. The mask may comprise any material that may be deposited or positioned on the carrier substrate. In certain embodiments, for example, the mask may comprise a sheet of a polymer (e.g., polyvinyl chloride (PVC), polyethylene terephthalate (PET)) with openings cut out in a desired pattern. In some cases, the mask comprises one or more magnetic components to facilitate a secure, removable attachment to the carrier substrate. An exemplary embodiment of a magnetic mask comprises a sheet of magnetized iron filings in a polymer binder matrix. In certain embodiments, the method comprises depositing the conductive material (e.g., via ink jetting or pad printing) according to a pattern on an unmasked carrier substrate.

In some embodiments, the carrier substrate is substantially flexible. In certain cases, the flexibility of the carrier substrate may allow electrodes to be transferred onto surfaces of any geometry (e.g., curved surfaces). In some embodiments, the carrier substrate comprises a polymer. A non-limiting example of a suitable polymer is polytetrafluoroethylene (PTFE).

In some embodiments, at least a portion of the carrier substrate comprises a conductive material (e.g., a carbon-containing conductive material, a metal-containing conductive material, a metal alloy, a conductive polymer, and/or any combination thereof). A non-limiting example of a suitable conductive material is mylar with a conductive material, such as aluminum-coated mylar. In some embodiments, at least a portion of the carrier substrate has undergone surface treatment.

In some embodiments, a carrier substrate may be positioned on a heat source (e.g., a heat plate) prior to the deposition of the conductive material. In certain cases, the heat source may facilitate the evaporation of any solvent in the deposited conductive material and result in solvent-free electrodes. The heat source may be set to greater than or equal to 50° C., greater than or equal to 70° C., or greater than or equal to 90° C. In some embodiments, at least a portion of the carrier substrate comprises a plurality of pores. In certain cases, the plurality of pores may facilitate the removal of any solvent in the deposited conductive material and result in solvent-free electrodes. In some instances, for example, suction may be applied to facilitate transport of solvent through the plurality of pores. In some cases, solvent-free electrodes may be more easily transferred to elastomer layers. In some cases, solvent-free electrodes may avoid any negative interactions between a solvent and an elastomer layer (e.g., swelling, beading). In some cases, solvent-free electrodes may avoid the need for a binder-curing step.

In some embodiments, at least a portion of one or more binders in the deposited conductive material may not be removed, and one or more electrodes may comprise one or more binders. In certain embodiments, the method of forming a DEA may comprise a step of curing deposited conductive material comprising one or more binders (e.g., a binder composite).

In some embodiments, the method of forming a DEA comprises a cleaning step and/or a doping step. The cleaning step may consist of removing unwanted material and maintaining a conductive network. The cleaning step may be performed after deposition of nanomaterials and may be performed before transfer to a final substrate.

In some embodiments, a substrate may be coated and may be exposed to chemical vapor processes to remove impurities of deposited materials, such as but not limited to nanomaterials.

The chemical vapor processes may include nitric acid treatment or another suitable surface treatment, such as that described in Worsley et al., “Functionalization and Dissolution of Nitric Acid Treated Single-Walled Carbon Nanotubes,” Journal of the American Chemical Society (2009), available at pubs.acs.org/doi/10.1021/ja906267g, which is hereby incorporated by reference in its entirety.

In some embodiments, deposited materials, such as CNTs or nanomaterial, may be exposed to superacids before transfer to the elastomer substrate. Without wishing to be bound by theory, exposure of the deposited materials to superacids can allow for the transformation of disordered particles into precise configurations. In the non-limiting example of CNTs as the deposited material, without wishing to be bound by theory, consequent washing can increase the conductivity.

In some embodiments, a doping step for facial doping of CNTs and other deposited electrodes is performed. The doping step may include chemical doping of local spots and/or patterns for the bulk of deposited materials. As non-limiting examples, the doping step may include doping of nanotubes by chemical dopants, doping of CNTs by annealing the device in a vacuum or in an inert gas, doping of CNTs by depositing polymer electrolytes, and/or doping of CNTs with alkali metals. As another non-limiting example, the doping step may include N-type doping by depositing a molecular dopant (such as, but not limited to, dimethyl-dihydro-benzoimi-dazoles (DMBI) or viologen molecules) by vacuum evaporation and/or as solution coating based onto the substrate with deposited CNTs. For deposited, single-walled carbon nanotubes, in a non-limiting example, a doping step may comprise direct redox reactions. The doping step may be used to alter the local and global electric properties of the material deposited before it is transferred onto an elastomer film.

In certain embodiments, the method of forming a DEA comprises depositing the conductive material on a plurality of portions of one or more carrier substrates to form a plurality of electrodes or film. In certain embodiments, the method of forming a DEA comprises depositing the conductive material on a plurality of portions of one carrier substrate. In certain embodiments, the method of forming a DEA comprises depositing the conductive material on a plurality of portions of a plurality of carrier substrates (e.g., one or more portions of a first carrier substrate and one or more portions of a second carrier substrate).

In some embodiments, the plurality of portions comprises at least 2, at least 5, at least 10, at least 20, at least 50, at least 100, at least 200, at least 500, at least 1000, at least 2000, at least 5000, or at least 10,000 portions. In certain embodiments, the plurality of portions comprises 2 to 5, 2 to 10, 2 to 20, 2 to 50, 2 to 100, 2 to 200, 2 to 500, 2 to 1000, 2 to 2000, 2 to 5000, 2 to 10,000, 10 to 50, 10 to 100, 10 to 200, 10 to 500, 10 to 1000, 10 to 2000, 10 to 5000, 10 to 10,000, 100 to 500, 100 to 1000, 100 to 2000, 100 to 5000, 100 to 10,000, 1000 to 5000, or 1000 to 10,000 portions.

Each portion of the plurality of portions may have any suitable geometry. In some embodiments, one or more portions (and, in some cases, all) of the plurality of portions are substantially circular, square, rectangular, triangular, trapezoidal, or irregularly shaped. In some embodiments, one or more portions (and, in some cases, all) of the plurality of portions are relatively large. In certain embodiments, one or more portions (and, in some cases, all) of the plurality of portions have an area of at least 62,500 mm² , at least 90,000 mm² , at least 100,000 mm², at least 122,500 mm² , at least 160,000 mm² , at least 200,000 mm² , at least 250,000 mm² , at least 278,400 mm² , at least 360,000 mm² , at least 490,000 mm² , at least 640,000 mm² , at least 810,000 mm² , or at least 1,000,000 mm² . In certain embodiments, one or more portions (and, in some cases, all) of the plurality of portions have an area in a range from 62,500 mm² to 90,000 mm², 62,500 mm² to 100,000 mm² , 62,500 mm² to 122,500 mm² , 62,500 mm² to 160,000 mm² , 62,500 mm² to 200,000 mm² , 62,500 mm² to 250,000 mm² , 62,500 mm² to 278,400 mm² , 62,500 mm² to 360,000 mm² , 62,500 mm² to 490,000 mm² , 62,500 mm² to 640,000 mm² , 62,500 mm² to 810,000 mm² , 62,500 mm² to 1,000,000 mm² , 90,000 mm² to 160,000 mm² , 90,000 mm² to 250,000 mm² , 90,000 mm² to 360,000 mm² , 90,000 mm² to 490,000 mm² , 90,000 mm² to 640,000 mm² , 90,000 mm² to 810,000 mm² , 90,000 mm² to 1,000,000 mm² , 160,000 mm² to 200,000 mm² , 160,000 mm² to 250,000 mm² , 160,000 mm² to 278,400 mm² , 160,000 mm² to 360,000 mm² , 160,000 mm² to 490,000 mm² , 160,000 mm² to 640,000 mm² , 160,000 mm² to 810,000 mm² , 160,000 mm² to 1,000,000 mm² , 250,000 mm² to 360,000 mm² , 250,000 mm² to 490,000 mm² , 250,000 mm² to 640,000 mm² , 250,000 mm² to 810,000 mm² , 250,000 mm² to 1,000,000 mm² , 360,000 mm² to 490,000 mm² , 360,000 mm² to 640,000 mm² , 360,000 mm² to 810,000 mm² , 360,000 mm² to 1,000,000 mm² , 490,000 mm² to 640,000 mm² , 490,000 mm² to 810,000 mm² , 490,000 mm² to 1,000,000 mm² , 640,000 mm² to 810,000 mm² , 640,000 mm² to 1,000,000 mm² , or 810,000 mm² to 1,000,000mm².

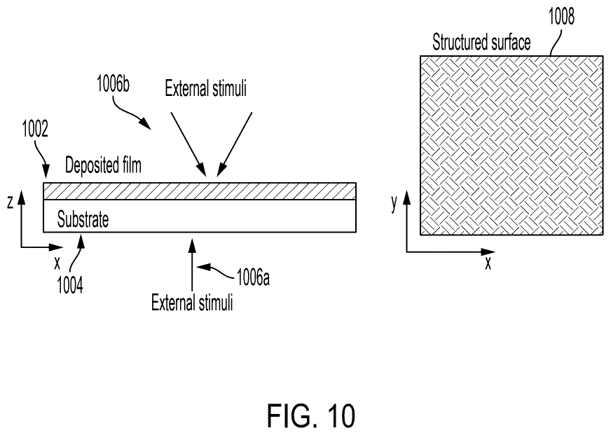

In some embodiments, the method of forming a DEA comprises, after depositing the conductive material on a carrier substrate, performing structuring and processing of electrodes or films (e.g., as shown in FIG. 10 described further herein). The structuring and processing may involve using a laser or another holographic method to tailor dielectric, electric, and optical properties of the electrode on the substrate locally and/or globally. The stimulus may include but is not limited to light, temperature, and a combination of light and temperature. Multiple stimuli may be used or a single stimulus may be used. While the electric properties can be tuned with the sprayed volume of the materials, the inventors have appreciated that a more delicate structure and a continuous transition of properties, such as resistance, may be difficult to achieve. Structuring and processing of electrodes or films may alter the transfer properties and therefore allow for the transfer of more delicate structures and/or enhance the transfer process. By manipulating or tailoring the deposited material, the conductivity can be changed, as can the interface and/or adhesion properties. As a non-limiting example, a carbon dioxide laser may be used. Manipulating the deposited electrode may provide fine-tuned gradients, instead of finite properties.

In some embodiments, the method of forming a DEA comprises, after depositing the conductive material on a carrier substrate to form one or more electrodes, performing one or more quality control tests on the one or more electrodes. In some embodiments, the one or more quality control tests comprise one or more electrical and/or mechanical as well as optical tests including but not limited to transmittance and haze measurements (if, as in some instances, the substrate and the deposited materials allow that). In certain instances, at least one quality control test comprises measuring resistance of the one or more electrodes. In certain instances, at least one quality control test comprises using impedance spectroscopy.

In some embodiments, the one or more electrodes can be characterized and/or modified before a transfer step. A substrate that may allow a transfer step can be equipped with a conductive metal electrode on either or both sides, including but not limited to silver, copper, and gold. Such a conductive metal electrode can be continuous or a metal mesh. A metal mesh may have a pitch of a few microns, such as but not limited to 5 μm to 1000 μm, or any value within that range and may have a line width of 1 μm to 10 μm, greater than μm, or any value within those ranges. A mesh may be disposed inside the substrate and/or may be on one or two sides of the substrate. After depositing nanomaterials, or other materials, to form a capacitor or participate within a resistive element, a direct measurement of the electric and/or dielectric, or optical parameters, may be done. By depositing an electrode, parameters, such as those involving a metal mesh, can change. The deposited material, which might be conductive, can change the resistance of the mesh as it affects the coverage. A smart material may be used for the substrate, thereby electric, dielectric, and optical signals may change and can be evaluated following deposition of a material, such as a nanomaterial. Capacitive tests through the substrate may be performed as can resistance tests. Since, in some embodiments, the electrode may not be a continuous electrode, transmittance and haze can be employed to pre-evaluate the coated substrate. Such measurements may allow for the evaluation of the deposited electrode(s).

As a non-limiting example, coverage of the electrode as a quality parameter may be determined and evaluated. Other parameters, such as optical parameters, may be used to evaluate deposited electrode(s) and/or nanomaterials. Optical parameters may include transmission and haze, and in some embodiments, optical profilometry may be performed to capture the thickness. Other characterization methods include but are not limited to instrumentation visual inspections, device resistance, contact or non-contact sheet resistance, roughness, sparsity, and dissipation factor. Quality control measurements may be facilitated on the electrode(s) or on the transfer substrate. Such measurements may also be taken after the electrode is transferred to a target substrate. Optimal parameters may depend on the targeted device.

In some embodiments, the method of forming a DEA comprises, after depositing the conductive material on a carrier substrate to form one or more electrodes, applying a modification step to the one or more electrodes. In certain instances, the modification step may be applied based on a result of one or more quality control tests performed on the one or more electrodes. The modification step may, in some cases, generate one or more electronic and/or structural changes in the one or more electrodes.

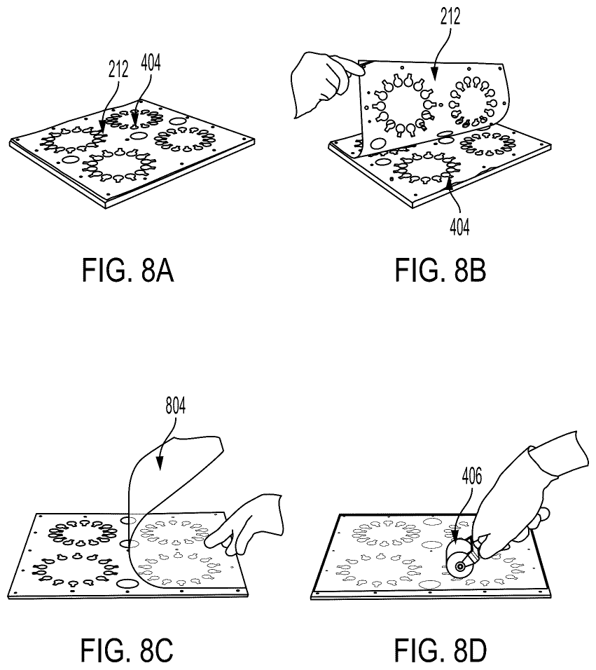

In certain embodiments, the modification step comprises a mechanical treatment step and/or a chemical treatment step or an exposure to light (e.g., UV). A non-limiting example of a suitable mechanical treatment step comprises applying pressure to the one or more electrodes (e.g., as shown in FIG. 8D described further herein). In some instances, for example, a smoothing layer may be positioned above the one or more electrodes, and pressure may be applied to at least a portion of the smoothing layer such that pressure is applied to at least a portion of the one or more electrodes. In certain cases, the pressure may be applied using a roller and/or a press. In some instances, the applied pressure is in a range from 1 atm to 2 atm, 1 atm to 5 atm, 1 atm to 10 atm, 2 atm to 5 atm, 2 atm to 10 atm, or 5 atm to 10 atm. The smoothing layer may be substantially flexible or substantially rigid. In certain cases, the smoothing layer comprises a polymer (e.g., PET, PVC), a metal, and/or a metal alloy. In some embodiments, the modification step comprises a plasma discharge treatment. In some embodiments, the modification step comprises applying an anti-static treatment to the one or more electrodes (e.g., using an anti-static gun to remove static from the surface of the one or more electrodes).

In some embodiments, applying a modification step (e.g., applying pressure) to the one or more electrodes may reduce defects in the one or more electrodes. In some cases, applying a modification step (e.g., applying pressure) to the one or more electrodes may advantageously decrease the surface roughness of the one or more electrodes. In certain embodiments, following the modification step, at least one of the one or more electrodes has an average surface roughness Ra of about 10 μm or less, about 5 μm or less, about 2 μm or less, or about 1 μm or less. In certain embodiments, following the modification step, at least one of the one or more electrodes has an average surface roughness Ra in a range from 1 μm to 2 μm, 1 μm to 5 μm, 1 μm to 10 μm, 2 μm to 5 μm, or 2 μm to 10 μm. In some cases, applying a modification step (e.g., applying pressure) to the one or more electrodes may advantageously increase the breakdown strength of the one or more electrodes.

In some embodiments, prior to stamping an electrode onto an elastomer, preclearing of the electrode may be performed, which may involve a self-clearing operation on the electrode. Preclearing can include applying a preclearing field through the stamp substrate and/or through the air, vacuum, or other gas, using corona discharge. Preclearing of the electrode may be performed to increase breakdown strength. Preclearing may be performed while the electrode is on a substrate and may be performed before assembly into a device.

In some embodiments, the method of forming a DEA comprises transferring at least a portion of an electrode (e.g., a first electrode of a plurality of electrodes) from one or more carrier substrates to a first elastomer layer to form a first electrode layer on the first elastomer layer.

In some embodiments, the transferring at least a portion of an electrode from one or more carrier substrates to the first elastomer layer comprises positioning the one or more carrier substrates such that the first electrode is facing the first elastomer layer and applying pressure to the one or more carrier substrates such that the first electrode is in physical contact with the first elastomer layer. In certain cases, the pressure may be applied to the one or more carrier substrates using a roller and/or a press. In some instances, the applied pressure is in a range from 1 atm to 2 atm, 1 atm to 5 atm, 1 atm to 10 atm, 2 atm to 5 atm, 2 atm to 10 atm, or 5 atm to 10 atm. In certain embodiments, the transferring at least a portion of an electrode from one or more carrier substrates comprises heating or cooling the one or more carrier substrates, applying tension to the one or more carrier substrates, and/or applying an electric field to the one or more carrier substrates.

In some embodiments, the transferring may include any suitable means of force, heat, e-field or light, that could enable the transfer. The transfer may include mechanic processes and processes that are not mechanic. Localized exposure to light may be used to facilitate a transfer. The transfer means may be applied to the carrier substrate. In some embodiments, the carrier substrate may be exposed to UV/heat, electric current and/or submerged into a suitable solvent. In a non-limiting example, ethanol, such as one drop to a few drops of ethanol, may be used to enhance de-adhesion of the electrode or film from the carrier substrate. The selected transfer means may promote the transfer of electrode(s) and film(s), such as functionalized films.

The first elastomer layer may comprise any elastomer known in the art. Non-limiting examples of suitable elastomers include natural rubber, silicones (e.g., PDMS, Ecoflex™ 00-30, Sylgard 184 (S184 ), Wacker P7670), acrylics (e.g., 3M™ VHB™ 4910), polyurethane, and thermoplastics (e.g., SEBS-styrene-co-ethylene-co-butylene-co-styrene). In some embodiments, the elastomer is substantially non-tacky. In some embodiments, the elastomer is substantially tacky.

In some embodiments, the method of forming a DEA comprises removing the one or more carrier substrates from the first elastomer layer after transferring at least a portion of the electrode from one or more carrier substrates to the first elastomer layer.

An electrode layer (e.g., the first electrode layer) may have any suitable size or geometry. In some embodiments, an electrode layer (e.g., the first electrode layer) is substantially circular, square, rectangular, triangular, trapezoidal, or irregularly shaped. In some embodiments, an electrode layer (e.g., the first electrode layer) is relatively large. In certain embodiments, an electrode layer (e.g., the first electrode layer) has an area of at least 62,500 mm² , at least 90,000 mm², at least 100,000 mm² , at least 122,500 mm² , at least 160,000 mm² , at least 200,000 mm² , at least 250,000 mm² , at least 278,400 mm² , at least 360,000 mm² , at least 490,000 mm² , at least 640,000 mm² , at least 810,000 mm² , or at least 1,000,000mm² . In certain embodiments, an electrode layer (e.g., the first electrode layer) has an area in a range from 62,500 mm² to 90,000 mm², 62,500 mm² to 100,000 mm² , 62,500 mm² to 122,500 mm² , 62,500 mm² to 160,000 mm² , 62,500 mm² to 200,000 mm² , 62,500 mm² to 250,000 mm² , 62,500 mm² to 278,400 mm² , 62,500 mm² to 360,000 mm² , 62,500 mm² to 490,000 mm² , 62,500 mm² to 640,000 mm² , 62,500 mm² to 810,000 mm² , 62,500 mm² to 1,000,000 mm² , 90,000 mm² to 160,000 mm² , 90,000 mm² to 250,000 mm² , 90,000 mm² to 360,000 mm² , 90,000 mm² to 490,000 mm² , 90,000 mm² to 640,000 mm² , 90,000 mm² to 810,000 mm² , 90,000 mm² to 1,000,000 mm² , 160,000 mm² to 200,000 mm² , 160,000 mm² to 250,000 mm² , 160,000 mm² to 278,400 mm² , 160,000 mm² to 360,000 mm² , 160,000 mm² to 490,000 mm² , 160,000 mm² to 640,000 mm² , 160,000 mm² to 810,000 mm² , 160,000 mm² to 1,000,000 mm² , 250,000 mm² to 360,000 mm² , 250,000 mm² to 490,000 mm² , 250,000 mm² to 640,000 mm² , 250,000 mm² to 810,000 mm² , 250,000 mm² to 1,000,000 mm² , 360,000 mm² to 490,000 mm² , 360,000 mm² to 640,000 mm² , 360,000 mm² to 810,000 mm² , 360,000 mm² to 1,000,000 mm² , 490,000 mm² to 640,000 mm² , 490,000 mm² to 810,000 mm² , 490,000 mm² to 1,000,000 mm² , 640,000 mm² to 810,000 mm² , 640,000 mm² to 1,000,000 mm² , or 810,000 mm² to 1,000,000mm².

In some embodiments, an electrode layer (e.g., the first electrode layer) has a thickness of at least about 0.4 nm, at least about 1 nm, at least about 10 nm, at least about 20 nm, at least about 30 nm, least about 40 nm, at least about 50 nm, at least about 100 nm, at least about 150 nm, at least about 200 nm, at least about 250 nm, at least about 300 nm, at least about 400 nm, at least about 500 nm, at least about 1 μm, at least about 2 μm, at least about 5 μm, at least about 7 μm, or at least about 10 μm. In some embodiments, an electrode layer (e.g., the first electrode layer) has a thickness in a range from 0.4 nm to 40 nm, 0.4 nm to 100 nm, 0.4 nm to 150 nm, 0.4 nm to 200 nm, 0.4 nm to 250 nm, 0.4 nm to 300 nm, 0.4 nm to 400 nm, 0.4 nm to 500 nm, 0.4 nm to 1 μm, 0.4 nm to 5 μm, 0.4 nm to 10 μm, 40 nm to 100 nm, 40 nm to 150 nm, 40 nm to 200 nm, 40 nm to 250 nm, 40 nm to 300 nm, 40 nm to 400 nm, 40 nm to 500 nm, 40 nm to 1 μm, 40 nm to 5 μm, 40 nm to 10 μm, 50 nm to 100 nm, 50 nm to 150 nm, 50 nm to 200 nm, 50 nm to 250 nm, 50 nm to 300 nm, 50 nm to 400 nm, 50 nm to 500 nm, 50 nm to 1 μm, 50 nm to 5 μm, 50 nm to 10 μm, 100 nm to 200 nm, 100 nm to 250 nm, 100 nm to 300 nm, 100 nm to 400 nm, 100 nm to 500 nm, 100 nm to 1 μm, 100 nm to 5 μm, 100 nm to 10 μm, 250 nm to 500 nm, 250 nm to 1 μm, 200 nm to 5 μm, 200 nm to 10 μm, 500 nm to 1 μm, 500 nm to 5 μm, 400 nm to 10 μm, 1 μm to 5 μm, 1 μm to 10 μm, or 5 μm to 10 μm.

In some embodiments, the method of forming a DEA comprises depositing a second elastomer layer on the first electrode layer. In certain embodiments, depositing the second elastomer layer comprises depositing an elastomer precursor on at least a portion of the first electrode layer. The elastomer precursor may be deposited using any deposition method known in the art. Non-limiting examples of suitable deposition methods include spin coating, doctor blading, spraying, and dry-film stacking. In some embodiments, depositing the second elastomer layer further comprises curing the elastomer precursor to form the second elastomer layer. In some cases, curing the elastomer precursor comprises exposing the elastomer precursor to heat, electromagnetic radiation (e.g., ultraviolet radiation), and/or a curing agent.

In some embodiments, an elastomer layer (e.g., the second elastomer layer) has a thickness of at least 3 μm, at least 5 μm, at least 10 μm, at least 20 μm, at least 30 μm, at least 40 μm, at least 50 μm, at least 60 μm, at least 70 μm, at least 80 μm, at least 90 μm, at least 100 μm, at least 200 μm, at least 500 μm, or at least 1 mm. In some embodiments, an elastomer layer (e.g., the second elastomer layer) has a thickness of 1 mm or less, 500 μm or less, 200 μm or less, 100 μm or less, 90 μm or less, 80 μm or less, 70 μm or less, 60 μm or less, 50 μm or less, 40 μm or less, 30 μm or less, 20 μm or less, 10 μm or less, 5 μm or less, or 3 μm or less. In some embodiments, an elastomer layer (e.g., the second elastomer layer) has a thickness in a range from 3 μm to 10 um, 3 μm to 20 μm, 3 μm to 50 μm, 3 μm to 70 μm, 3 μm to 100 μm, 3 μm to 200 μm, 3 μm to 500 μm, 3 μm to 1 mm, 5 μm to 10 μm, 5 μm to 20 μm, 5 μm to 50 μm, 5 μm to 70 μm, 5 μm to 100 μm, 5 μm to 200 μm, 5 μm to 500 μm, 5 μm to 1 mm, 10 μm to 20 μm, 10 μm to 50 μm, 10 μm to 70 μm, 10 μm to 100 μm, 10 μm to 200 μm, 10 μm to 500 μm, 10 μm to 1 mm, 20 μm to 50 μm, 20 μm to 70 μm, 20 μm to 100 μm, 20 μm to 200 μm, 20 μm to 500 μm, 20 μm to 1 mm, 50 μm to 70 μm, 50 μm to 100 μm, 50 μm to 200 μm, 50 μm to 500 μm, 50 μm to 1 mm, 70 μm to 100 μm, 70 μm to 200 μm, 70 μm to 500 μm, 70 μm to 1 mm, 100 μm to 200 μm, 100 μm to 500 μm, 100 μm to 1 mm, 200 μm to 500 μm, 200 μm to 1 mm, or 500 μm to 1 mm.

In some embodiments, the method of forming a DEA comprises transferring at least a portion of a second electrode of a plurality of electrodes from one or more carrier substrates to the second elastomer layer to form a second electrode layer on the second elastomer layer.

In some embodiments, the transferring at least a portion of a second electrode from one or more carrier substrates to the second elastomer layer comprises positioning the one or more carrier substrates such that the second electrode is facing the second elastomer layer and applying pressure to the one or more carrier substrates such that the second electrode is in physical contact with the second elastomer layer. In certain cases, the pressure may be applied to the one or more carrier substrates using a roller and/or a press. In some instances, the applied pressure is in a range from 1 atm to 2 atm, 1 atm to 5 atm, 1 atm to 10 atm, 2 atm to 5 atm, 2 atm to 10 atm, or 5 atm to 10 atm. In certain embodiments, the transferring at least a portion of an electrode from one or more carrier substrates comprises heating or cooling the one or more carrier substrates, applying tension to the one or more carrier substrates, and/or applying an electric field to the one or more carrier substrates.

In some embodiments, the method of forming a DEA comprises repeating the steps of depositing an elastomer layer and transferring an electrode to the elastomer layer until a desired number of layers has been reached.

In some embodiments, the method of forming a DEA comprises forming a plurality of stacks, each stack comprising an electrode layer and an elastomer layer, and laminating at least two stacks of the plurality of stacks together to form the DEA. In certain embodiments, the method comprises depositing a conductive material on a plurality of portions of one or more carrier substrates to form a plurality of electrodes. In certain embodiments, the method comprises transferring at least two electrodes of the plurality of electrodes from the one or more carrier substrates to a plurality of elastomer layers to form a plurality of stacks. In certain embodiments, the method comprises laminating at least two stacks of the plurality of stacks together to form the DEA.

In some embodiments, a DEA comprises at least 2, at least 5, at least 10, at least 20, at least 50, at least 60, at least 100, at least 200, at least 500, at least 1000, at least 2000, at least 5000, or at least 10,000 pairs of electrode layers and elastomer layers. In certain embodiments, the DEA comprises 2 to 5, 2 to 10, 2 to 20, 2 to 50, 2 to 60, 2 to 100, 2 to 200, 2 to 500, 2 to 1000, 2 to 2000, 2 to 5000, 2 to 10,000, 10 to 50, 10 to 100, 10 to 200, 10 to 500, 10 to 1000, 10 to 2000, 10 to 5000, 10 to 10,000, 100 to 500, 100 to 1000, 100 to 2000, 100 to 5000, 100 to 10,000, 1000 to 5000, or 1000 to 10,000 pairs of electrode layers and elastomer layers.

The DEA may have any suitable size or geometry. In some embodiments, the DEA has a substantially circular, square, rectangular, triangular, trapezoidal, or irregularly shaped cross section. In some embodiments, the DEA is substantially cylindrical, substantially a rectangular prism, substantially spherical, or substantially cubical. In some embodiments, the DEA has a substantially tubular or fibrous shape. In some embodiments, the DEA has a complex geometry and/or comprises one or more uneven surfaces.

In certain embodiments, the DEA has a largest cross-sectional dimension of at least 15 mm, at least 17.5 mm, at least 20 mm, at least 50 mm, at least 100 mm, at least 150 mm, at least 200 mm, at least 500 mm, at least 700 mm, or at least 1 m. In certain embodiments, the DEA has a largest cross-sectional dimension in a range from 15 mm to 20 mm, 15 mm to 50 mm, 15 mm to 100 mm, 15 mm to 150 mm, 15 mm to 200 mm, 15 mm to 500 mm, 15 mm to 700 mm, 15 mm to 1 m, 50 mm to 100 mm, 50 mm to 150 mm, 50 mm to 200 mm, 50 mm to 500 mm, 50 mm to 700 mm, 50 mm to 1 m, 100 mm to 200 mm, 100 mm to 500 mm, 100 mm to 700 mm, 100 mm to 1 m, 500 mm to 700 mm, or 500 mm to 1 m.

The aspects and embodiments described above, as well as additional aspects and embodiments, are described further below. These aspects and/or embodiments may be used individually, all together, or in any combination of two or more, as the application is not limited in this respect.

### EXAMPLE

This non-limiting Example presents a novel fabrication paradigm that overcomes the challenges associated with existing processes of manufacturing multilayer dielectric elastomer actuators: instead of sequentially patterning electrodes directly onto successive elastomer layers, electrode stamps were patterned onto a carrier film in an independent batch-spray process and the electrodes were then stamp-transferred onto each elastomer layer. By modularizing the production and assembly of electrodes, a laboratory-scale implementation of the process achieved a throughput of 15 layers per hour, a maximum electrode size of 300×300 mm, and tuning-free compatibility with a wide range of elastomers. The batch-spraying paradigm also provided the unique capability to evaluate and modify electrodes before they were assembled into a multilayer; a method of mechanically treating the electrodes was employed to increase the breakdown strength of Elastosil P7670 devices from 15.7 to 33.5 V μm⁻¹. The electrodes were conductive up to a strain of more than 200% and added negligible stiffness to the multilayer structure. The capabilities of this process to produce useful devices were demonstrated with a large-area loudspeaker and an actuator with 60 active layers.

More than 20 years after Pelrine, et al. catalyzed research into soft, energy-dense dielectric elastomer actuators (DEAs) and despite a strong projected market for soft actuators, DEAs are not yet commercially relevant. Many challenges such as modeling, design, and materials development have already been addressed: DEAs have been successfully modeled analytically and numerically; self-sensing and closed-loop control have been demonstrated; pre-stretching has been used to increase actuation strain and ameliorate electromechanical instabilities; elastomers with enhanced electromechanical properties such as increased permittivity, tailored stiffness, and reduced viscoelasticity have been developed; and compelling applications such as compression garments, haptic interfaces, and prostheses have been identified. Manufacturing of multilayer DEAs (MDEAs), however, remains a barrier to their widespread adoption.

MDEAs are crucial for generating large forces and displacements without excessively high voltages. Comprised of tens to hundreds of thin (often 10-100 μm) DEA layers that have been stacked atop each other, MDEAs'force and displacement outputs scale proportionally with the number of layers. A single-layer DEA with the same output would require a membrane tens to hundreds of times thicker and thus a voltage tens to hundreds of times higher to maintain the driving electrical field; 1-mm-thick DEAs often require tens of kV to actuate, and such voltages require impractically bulky and expensive drive electronics. Thus, unlike single-layer DEAs, MDEAs can be arbitrarily scaled to meet application-specific force and displacement requirements without requiring changes to actuator design, materials, or drive electronics.

Fabricating MDEAs, however, remains a key technical challenge for their widespread use, since many electrode layers are alternated with an equal number of thin, delicate elastomer layers, and these electrodes should meet several performance requirements, including being conductive (less than 100 kΩ/square, less than 1 MΩ/square), flexible and stretchable (greater than 100% elongation), and contributing minimal stiffness to the MDEA composite structure. They also should not reduce the breakdown strength of the elastomer. For scalability to an industrial process, it should also be possible to produce large-area electrodes and quickly deposit them onto the elastomer surface. To be useful in a variety of applications, the electrodes should also be compatible with a wide range of elastomers. The criteria that should be met by an MDEA fabrication process are: 1) high throughput (e.g., 10 layers/hour), 2) large electrode area (e.g., at least 250×250 mm), and 3) a wide range of compatible elastomer materials. A throughput of at least 10 DEA layers per hour may allow an operator to produce a multilayer of about 10 layers each hour or a multilayer with about 100 layers in a workday. The time to produce a layer excludes the time to cure and degas the elastomer and to batch-produce components; cure and degas times vary widely because of their dependence on elastomer properties such as elastomer chemistry and viscosity, and batch production can be completed in parallel with other steps. Electrodes larger than 250×250 mm may enable larger devices such as compression garments and robotic manipulators to be manufactured in a single piece. A wide range of compatible elastomers may allow designers to select the best possible material for their application and incorporate new elastomers as they are developed. To accommodate such a range, a process should not depend heavily on properties such as surface energy, viscosity, and degree of swelling and degradation in the presence of a solvent. Electrode deposition processes in which a wet electrode ink contacts an elastomer layer tend to introduce complications due to the many solvent-elastomer interactions that might cause dimensional changes and long-term degradation under electric field. This either leads to a limited set of usable elastomers or significant tuning which could slow the process's adoption for new applications.

Previously-proposed MDEA fabrication processes are unable to meet at least one of these objectives. For example, the manual mask and stamp transfer process for building MDEAs has the advantage of being usable for most elastomers, but it requires significant time (about 3-5 minutes) and skill to align flexible masks and PTFE filters with the substrate. And while the commercially-sourced filters (Advantec, T050A090C) could be scaled up in area, doing so would be prohibitively expensive—each 92 mm filter costs approximately $10 and can only be used a few times before performance degrades.

Jetting-based systems have also been proposed for printing multilayers. However, dissolving elastomers and/or conductive inks in a solution necessitates a difficult and time-consuming tuning of a large number of oft-conflicting process parameters such as viscosity and surface tension. Moreover, jetting processes tend to have low layer throughputs due to flow rate limitations. For example, devices with only a single active layer may require 4-4.5 hours to print.

Gravure, slot-die, screen-printing, and pad-printing based deposition methods for elastomers and conductive inks can achieve large electrode sizes and possibly high throughput, however the wet-ink deposition process produces similar challenges to those seen in jetting processes; phenomena such as the coffee ring effect can introduce spatial inhomogeneities in the electrodes, and incompatible solvents can swell elastomers, deforming the actuator as each electrode is printed.

The throughput of many of these processes can be enhanced by an added step of folding a large single layer multiple times, rolling up films or short stacks (about 10 layers), or simply assembling these short stacks into taller meta-stacks. These strategies can produce thick multilayers of hundreds of layers, but inherently sacrifice electrode area for layer throughput, and therefore cannot also produce multilayers with large electrode areas. The final geometry of the MDEA is also limited by the folding process; rolling methods, for example, generally produce cylindrical structures with a single actuation mode of uniaxial extension. Moreover, if the electrode is deposited with a wet-ink deposition process, significant process tuning may still be required beyond a narrow range of elastomers.

The multilayer DEA fabrication method of this Example, illustrated in FIG. 1, overcame these challenges by splitting electrode deposition into two independent processes: electrode spraying and electrode stamping. FIGS. 1A-1 to 1C-3 show, according to some embodiments, a schematic diagram of an exemplary batch-spray and stamp-transfer process.

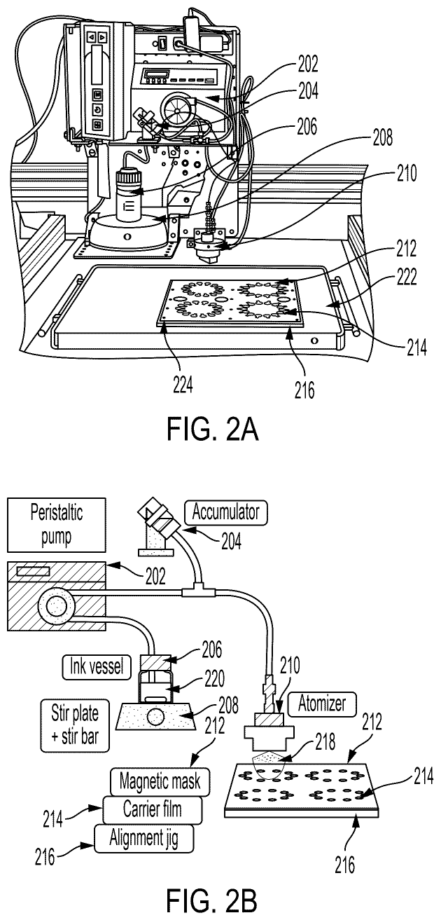

FIGS. 1A-1 to 1A-5 show, according to some embodiments, an exemplary process for batch spraying carbon black (CB) electrodes. In FIG. 1A-1, a magnetic mask 102 with a stencil of the desired pattern is aligned with pins 106 and placed atop the PTFE carrier film 104. The mask may be positioned or deposited prior to deposition of material. In FIG. 1A-2, CB ink 112 is atomized using atomizer 110 and sprayed onto at least one masked carrier film 104. In FIG. 1A-3, the magnetic mask 102 is removed, and the carrier film 104 with patterned CB electrodes 114 on it is removed from the jig 108, which may be made from steel or another suitable material. In FIG. 1A-4, a sheet of polyethylene terephthalate (PET) 118 is placed on top of the CB electrodes 114, and a roller 116 is used to apply pressure and reduce peaks on the electrode surface. While PET is shown, the sheet may comprise a polymer (e.g., PET, PVC), a metal, and/or a metal alloy. In FIG. 1A-5, the roll-treated CB electrodes 114 are shown stored in an oven 120 at 70° C. to keep them dry until they are used. The oven 120 may be set to greater than or equal to 70° C., greater than or equal to 80° C., or greater than or equal to 90° C. While an oven is shown in FIG. 1A-5, additionally or alternatively, a humidity controlled chamber, such as a dry cabinet, may be used to store electrodes.

FIGS. 1B-1 to 1B-2 show, according to some embodiments, an exemplary process for depositing an elastomer layer. In FIG. 1B-1, elastomer precursor 124 is deposited on top of the last electrode layer. As shown, a doctor blade 122 may be used to remove excess elastomer precursor 124. In FIG. 1B-2, the elastomer precursor 124 is cured with a UV light source 130 and/or a heat source 128 depending on the elastomer cure requirements, resulting in cured elastomer.

FIGS. 1C-1 to 1C-3 show, according to some embodiments, an exemplary process for stamping an electrode onto the elastomer surface. In FIG. 1C-1, a face-down electrode 132 is aligned with the multilayer using pins 106 which may be alignment pins. In FIG. 1C-2, a roller 116 applies pressure to the back of the carrier film 104, ensuring contact and transfer of the CB powder to the elastomer, and as in FIG. 1C-2, to the cured elastomer 126. In FIG. 1C-3, the carrier film 104 is lifted away, leaving the electrode 132 patterned on the surface. Steps 1B-1 to 1B-2 and 1C-1 to 1C-3 may be repeated until the desired number of layers has been reached. A DEA may include the first CB electrode(s) 114, the second electrode(s) 132 and the cured elastomer 126 layer therebetween.

### Method Description

First, carbon black (CB) electrodes were sprayed onto a masked substrate in large batches (e.g., as shown in FIGS. 1A-1 to 1A-5). The electrodes, made of a network of loose powder, were then quickly stamp-transferred onto successive elastomer layers to construct the MDEA. This dramatically reduced the sequential portion of electrode deposition that limits throughput, allowing a rate of 15 layers per hour to be achieved at laboratory scales. The batch spraying may be scaled to larger electrode areas by modifying the size of the spray gantry's raster path and using larger substrates; in this Example, maximum sprayable areas of 300×300 mm are presented, and this could be further scaled in future work, since the sprayable area is not so limited. Since the CB stamps were composed of binderless networks of CB powder, they transferred readily even to relatively non-tacky elastomers such as Ecoflex™ 00-30. Unlike wet-deposition methods, the dry stamping also has no solvent-elastomer interactions which would otherwise limit compatible elastomers or necessitate intensive tuning of the process for each elastomer. This allows for the process to be used with a wide range of elastomers with minimal tuning.

For this Example, the CB electrodes stretched by over 200% without loss of conductivity, did not degrade after 100 strain cycles, and contributed negligible stiffness to the multi-layer. Breakdown strengths of 33.5 V μm⁻¹ across 32.7 μm Elastosil P7670 membranes were achieved by mechanically treating the electrodes before they were assembled into a multilayer.

The utility of this process was demonstrated through two devices: a 200 mm diameter DEA subwoofer demonstrated the utility of large electrode sizes, and a 60-layer MDEA showed the displacements in both thickness and in-plane directions that can be harnessed with a many-layered MDEA.

For this Example, carbon black (CB, PRINTEX® XE2-B) dispersed in isopropanol (IPA) was used as a sprayable electrode dispersion. Both CB and IPA are inexpensive and widely available, making the ink cheap and easy to produce. The ink was dispensed with a peristaltic pump, broken into micron-sized droplets with an ultrasonic atomizer (Sonaer, NS130K), and ejected onto a polytetrafluoroethylene (PTFE) carrier substrate that had been masked with a vinyl-cut magnetic stencil of the desired electrode pattern. This process is shown in FIGS. 2A and 2B. The masks can be designed in computer-aided design software and exported to a vinyl cutter (Cricut Maker), and the tight magnetic seal allows for sharp features as small as 1 mm. A heat plate underneath the substrate evaporated the IPA in the ink from the PTFE surface, leaving behind a binderless network of loose CB powder. This loose powder stamp can easily transfer even to minimally-tacky elastomers. Moreover, it avoids an extra binder-curing step and does not contain any solvent that could swell or bead up on the elastomer layer it contacts.

In FIG. 2A, an exemplary deposition system was mounted on a gantry head that was capable of moving over a 580×480 mm heat plate, according to some embodiments.

In FIG. 2B, a stir assembly 208 including a stir bar and magnetic stir plate may stir the ink 220 above it at approximately 300 rpm to maintain a well-dispersed solution which would otherwise settle out in approximately 10-30 minutes. A peristaltic pump 202 may draw the ink 220 out of its ink vessel 206. While a peristaltic pump is shown in FIGS. 2A and 2B, any suitable positive displacement pump for drawing out a liquid may be used. An upside-down scintillation vial may function as an accumulator 204, preventing backflow and reducing pressure variations as the ink travels towards the atomizer 210 (e.g., atomizer 110 shown in FIG. 1A-2). The ink 220 may then be broken into approximately 10 μm diameter droplets by the atomizer 210 and ejected from the nozzle by approximately 60 kPa of supplied air pressure, resulting in ink spray 218. In some instances, droplets land on the masked substrate below and evaporate quickly on the heat plate 222 set to 80° C. The heat plate may be set to greater than or equal to 50° C., greater than or equal to 60° C., greater than or equal to 70° C., greater than or equal to 80° C., or greater than or equal to 90° C. As shown in FIGS. 2A and 2B, magnetic mask 212 (e.g., magnetic mask 102 shown in FIG. 1) is on a carrier film 214 (e.g., carrier film 104 shown in FIG. 1). Alignment jig 216 (e.g., jig 108 shown in FIG. 1A-1) may include a plurality of alignment pins 224 (e.g., pins 106 shown in FIG. 1). While carrier film 214 is shown as a single carrier film, carrier film 214 may be separated films. There may be two or more carrier substrates, thereby depositing material on carrier film 214 may include depositing material on a first carrier substrate and a second carrier substrate. Electrodes to be used for a same DEA may be deposited on a same carrier substrate or a different carrier substrate.

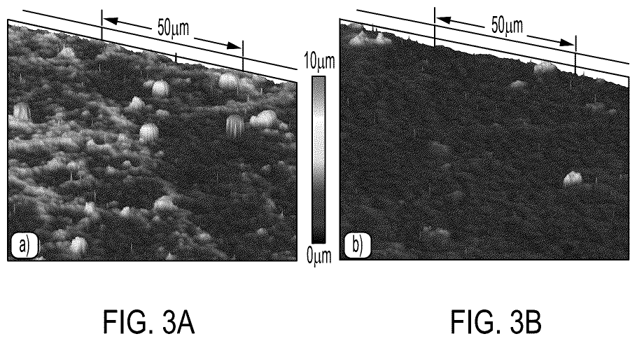

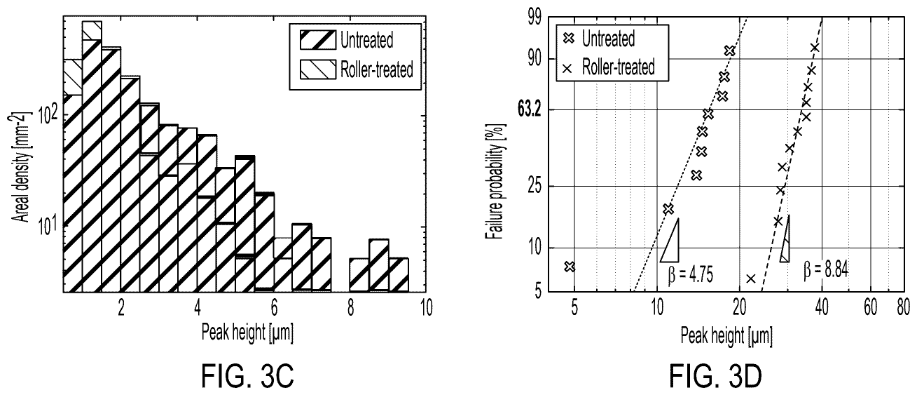

Unlike processes in which electrodes are directly deposited onto the elastomer, the batch-spraying paradigm allows for the electrodes to be evaluated and modified before they are integrated into the multilayer structure. After the electrodes are sprayed, in the Example, they were mechanically treated to roughly double the breakdown strength. A roller was used to apply pressure to a layer of PET atop the sprayed electrode. FIG. 3 shows how this produced a much flatter topography and/or topology, reducing the prevalence of peaks taller than 5 μm from 120 mm⁻² to 13 mm⁻² . This reduction in peaks can reduce electrical field concentrations that could result in premature dielectric failure (breakdown). Additional treatments may be developed to further improve the electrodes'performance.

In FIG. 3A, an Olympus OLS4000 laser microscope was used to obtain a height map of the surface of an untreated electrode while it was still on the PTFE carrier film. Many tall peaks on the order of 10 μm were visible. In FIG. 3B, after mechanical treatment, these peaks were dramatically reduced. As shown by this representative height map of an electrode after treatment, peaks taller than 5 μm were mostly eliminated. In FIG. 3C, six 256×256 μm images were taken at random points across electrodes from the same batch, before and after mechanical treatment. Peak-finding code was used to identify all peaks in the 2D image space, and the distribution of their heights was plotted as a histogram. Peaks shorter than 0.5 μm were ignored. The higher peaks were dramatically reduced in number as a result of the treatment. This may have reduced localized surface stresses and field concentrations that would have caused premature electrical breakdown. In FIG. 3D, the Weibull plot for N=11 treated and 9 untreated specimens tested to failure is shown. Each data point represents the breakdown field of a single specimen, fit to a Weibull distribution. The plot indicates that the treated specimens showed over 100% higher breakdown strength Eb compared to the untreated −33.5 vs 15.7 V μm^{μ1}. The treated electrodes were also more consistent, with a Weibull shape factor of treated β_{treated}=8.84 vs β_{untreated}=4.75.

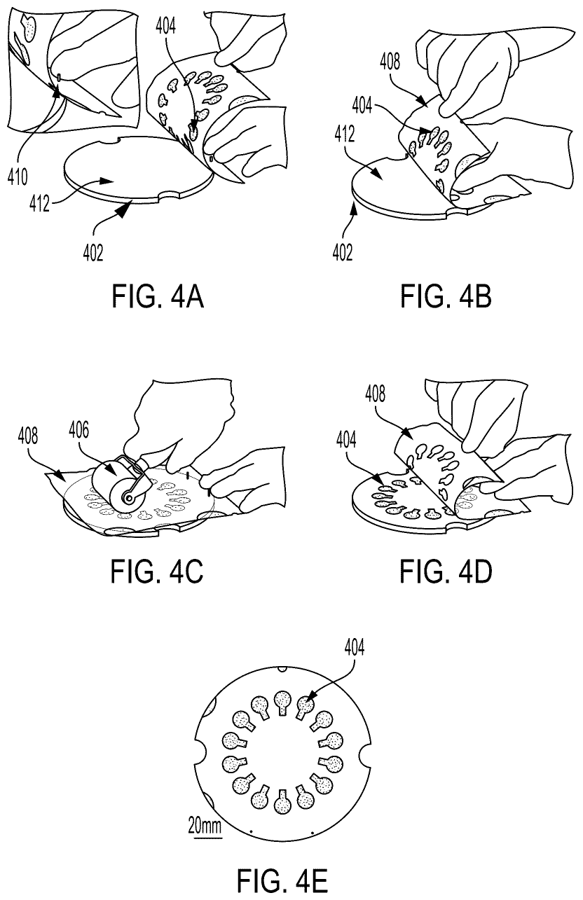

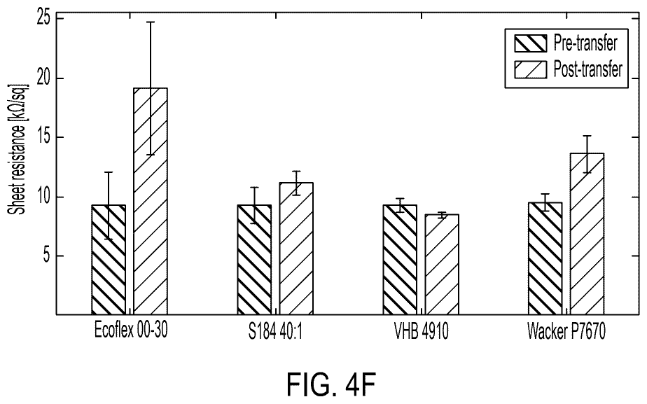

The electrodes were assembled into MDEAs by using pins and precut alignment holes in the substrates to align them with a cured elastomer substrate. In this Example, Elastosil® P7670 A/B (Wacker Chemie AG) was used in part because of its low stiffness (Y=220 kPa). To ensure that the CB transferred to the elastomer, a roller was then used to apply pressure to the back of the carrier film. FIGS. 4A-4E demonstrate how, as the carrier film was peeled off the elastomer, the CB transferred to the elastomer. The final thickness of the transferred electrode on the P7670 was approximately 240 nm. The entire alignment and stamping process required approximately one to two minutes by hand and may be accelerated with an automated roll-to-roll setup. Because the carrier film was flexible, it was also possible to transfer electrodes onto curved surfaces.

An elastomer layer was then deposited (e.g., via spin-coating or doctor-blading), degassed, and cured on the existing stack, and an electrode was stamp-transferred. This procedure was repeated until the desired number of layers had been reached. Excluding the elastomer-dependent cure and degas times, this process took only four minutes per layer (two minutes each for the deposition and transfer steps).

In more detail, after mechanical treatment as previously-described (e.g., in relation to FIG. 3B), the full 300×300 mm sheet was cut with scissors into fourths for transfer onto a smaller, 150 mm diameter. In FIG. 4A, precut alignment holes in the PTFE carrier film were aligned with pins 410 in corresponding alignment holes in the acrylic substrate 402 which has film 412, such as but not limited to, Elastosil P7670 disposed thereon. While the substrate 402 is acrylic, another suitable substrate may be used. As shown in FIG. 4B, the carrier film 408 (e.g., carrier film 104 shown in FIG. 1A-1) was rolled out onto the elastomer substrate. The electrode may be transferred to a suitable dielectric elastomer, as described herein.

In FIG. 4C, a roller 406 (e.g., roller 116 shown in FIG. 1A-4) was used to stamp-transfer the electrodes 404 (e.g., CB electrode 114 shown in FIG. 1A-4) onto the elastomer. While a roller is shown, a press may alternatively or additionally be used. While an operator is shown applying the roller in FIG. 4C, an automatic device, such as a robotic arm, may be used alternatively or additionally to apply the roller and/or press. In FIG. 4D, the carrier film 408, PTFE film in this non-limiting embodiment, was removed to be either discarded or cleaned and reused. After this step, an anti-static gun may be used on the surface to prevent dust accumulation (not shown). In FIG. 4E, an overhead view of the final transferred electrode 404 is shown. The diameter of the electrodes is 20 mm, in the non-limiting example of FIG. 4E.

In FIG. 4F, an effect of transferring the electrode 404 from carrier film 408 to various elastomer substrates is shown. Each bar represents the mean sheet resistance of three 20 mm specimens measured both before and after the transfer operation using a four-point probe. As shown in FIG. 4F, the electrode was successfully transferred to each elastomer evaluated. The change in electrode sheet resistance after transfer ranged from approximately 9% for the tacky VHB4910 to +106% for the non-tacky Ecoflex 00-30. The range in this ratio may be explained by tackier elastomers such as VHB being able to transfer more of the CB than less-tacky elastomers such as Ecoflex 00-30. Though the resistance typically increased after the stamp-transfer, the electrodes demonstrated a mean post-transfer sheet resistance (<20 kΩ/sq) for all tested elastomers, comparable to other binderless networks of CB used for DEAs. With only moderate dependence on material properties, it should be possible to use the batch spray and stamp process with a wide range of elastomers, and with a range of elastomer deposition processes, such as spin-coating, spray deposition, and dry-film stacking. The latter may be particularly appealing, since one of the main constraints on total MDEA fabrication time using the batch-spray and stamp-transfer method is the sequential deposition, degas, and cure time of the elastomer. These steps may take two, four, and five minutes, respectively, with the P7670 elastomer and spin-coating elastomer deposition method used. A dry-film fabrication method would obviate each of these steps.

Each of the batch-spray and stamp fabrication steps could also be implemented as a roll-to-roll process to dramatically increase throughput.

### Electrode Characterization

In the Example, the resistance-strain behavior of the electrodes was examined using a dogbone-shaped electrode design stacked into multilayers of five 30 μm elastomer layers and four 10×25 mm electrode layers. These multilayer samples were mounted in an Instron 5544A tensile tester. A strain rate of 1%/s was used for rupture and cyclic tests while the resistance across the sample was recorded using an LCR meter (Keysight E4980A). Three samples were cycled from 10% strain to 110% and then tested from 0% to rupture. The same was done with elastomer-only samples of the same size.

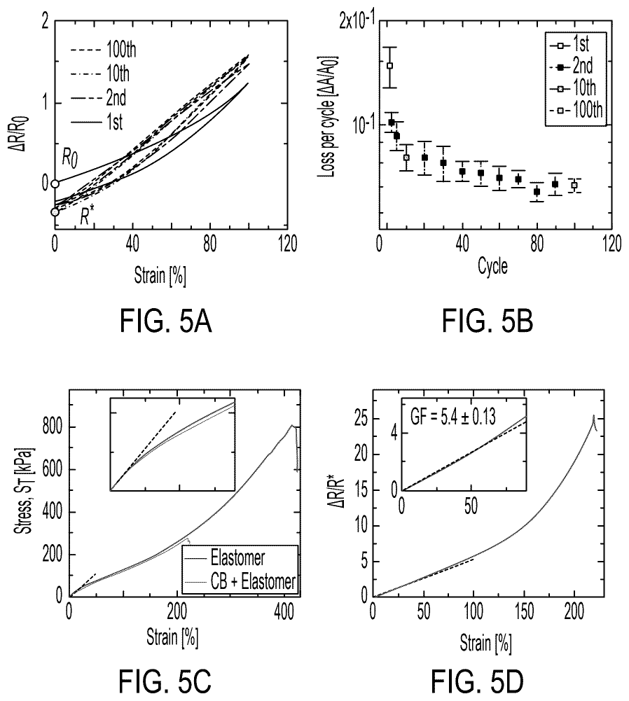

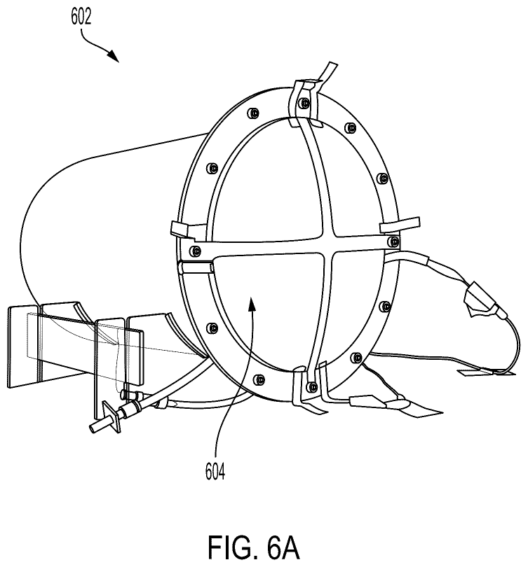

FIGS. 5A-5D show, according to some embodiments, a characterization of multilayered elastomer samples with and without CB layers under uniaxial tensile strain. Each curve plots a single representative sample out of the three that were tested for each condition. FIG. 5A shows relative resistance-strain curves for selected strain cycles. Samples were pre-strained by 10% for the cycling experiments. The cycles tended to overlap and stabilize after fewer than 10 cycles. FIG. 5B shows hysteresis vs. cycle number. The hysteresis decreased from ΔA/A₀=14.8% in the first cycle to 6.7% in the 100th. FIG. 5C shows samples strained to rupture. At small strains, the samples exhibited comparable stiffness (Y_{CB}=220±4.8 kPa for samples with CB vs. YP₇₆₇₀=219±3.7 kPa for samples without CB), however rupture occurred much earlier in the samples with CB electrodes (219% vs 430%). FIG. 5D shows a plot of relative resistance vs. strain up to rupture in a representative electrode sample. The initial resistance of the sample R₀ was 315 kΩ. The electrodes remained conductive up to mechanical rupture while the resistance-strain relationship was linear up to 100% strain with a GF of 5.4±0.13 for the three samples tested.

FIGS. 5A-5D present the rupture strain results of a sample fabricated with and without CB electrodes. A comparison of both sets indicates no impact of the electrodes on the stiffness at either small or large strains. The electrodes also remained conductive until they mechanically ruptured, in the case shown at 225% strain. Furthermore they exhibited good linearity below 100% strain with a gauge factor (GF) of 5.4±0.13 for the chosen design. To ensure that the samples remained under tension while cycling, a pre-strain of 10% was applied in addition to the indicated strains in FIG. 5A. The measured resistance during cyclic experiments exhibited hysteresis, but this hysteresis decreased and then stabilized; the ratio of the area inside the hysteresis loop ΔA to the total area under the first loading curve Ao decreased from 14.8% on the 1 st cycle to 6.7% on the 100th. These electromechanical characteristics may also make the electrode suitable for use as soft strain sensors or as energy harvesters.

Breakdown tests were performed on encapsulated single-layer DEAs produced with batch-sprayed electrodes. A 10 V/s voltage ramp was applied across the 32.7 μm P7670 DEA layer until the device experienced electrical failure (breakdown). The electrical field at which each specimen failed was plotted, as shown in FIG. 3D, along a Weibull fit of the data. The breakdown strength was taken as the shape factor of this fit, which was also the field at which there is a 1−e⁻¹=63.2% chance of failure, and the shape factor represented the slope on the Weibull plot and thus served as a metric of reliability.

As indicated in FIG. 3D, the DEAs manufactured in this Example had a breakdown strength of 33.5 V μm⁻¹ and a shape factor of 8.84. The upper bound of breakdown strength for a DEA, however, should be that of the pure elastomer. It has been found that the breakdown strength of the P 7670 was 64 V μm⁻¹ with a shape factor of 9.33.

Some of the difference between breakdown strength with and without CB electrodes may have been due to the contact area of the electrodes being approximately 20 times larger than that of the pure material test setup, increasing the chance of defects in the enclosed elastomer. Remaining defects in the electrodes may have reduced the breakdown strength-reducing their relative influence by increasing the elastomer thickness to 71.4 μm yielded an enhanced breakdown strength of 41.2 V μm⁻¹.

These breakdown characteristics may be further improved by further tuning the mechanical treatment process and/or reducing the presence of agglomerations in the ink. This may enable even larger and more energy-dense actuators.

### Demonstration Devices

A DEA subwoofer was selected to illustrate the functionalities enabled by the large electrodes that can be produced with this process.

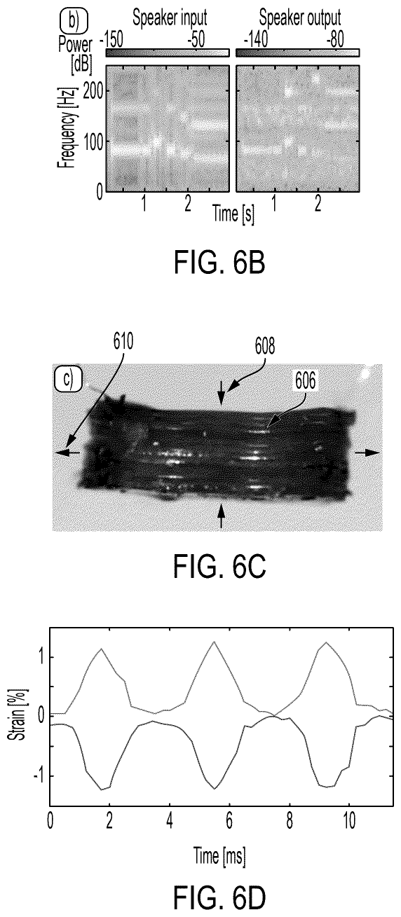

FIG. 6A shows an exemplary demonstration device, according to some embodiments.

FIG. 6A shows a view of an exemplary speaker from the front. The diameter of the membrane 604 of the demonstration device 602 was 200 mm. FIG. 6B shows a comparison of the speaker input and output spectrograms and illustrates the scalability of the process. Power measures were arbitrarily defined relative to the strength of the overall signal, not relative to sound pressure levels.

FIG. 6B demonstrates that the speaker was able to reproduce the low-frequency sounds (20-200 Hz) expected of a subwoofer. The decreased signal to noise ratio of the output was due to a combination of sub-optimal recording environment, relative weakness of the speaker compared to the original audio output, and clipping causing harmonic distortion at higher volumes.

FIG. 6C shows a side view of an exemplary 60-layer MDEA 606, with principal directions of strain indicated by arrows. The left and right arrows, horizontal arrows 610, represent the direction of horizontal strain, and the top and bottom arrows, vertical arrows 608, represent the direction of vertical strain. The speaker was suspended by its lead wires in a free displacement condition. A device such as the MDEA of FIG. 6C may be formed using processes described herein individually, all together, or in any combination of two or more.

FIG. 6D shows three selected strain cycles of the actuator, MDEA 606, in response to a 200 Hz, 0-2 kV sinusoidal input signal. The device reached horizontal strains of 1.24%, shown by the topmost curvature in FIG. 6D, and vertical strains of 1.23%, shown by the bottom curvature.

The speaker was comprised of a 200 mm diameter single-layer DEA stretched over an air-pressurized chamber. The DEA was created by first doctor-blading, degassing, and fully curing a 70 μm film of P7670. Doctor blading may be scalable to large areas, and is thus suitable for such large-area actuators. Electrodes patterned into the shape of a quartered disk were then stamped onto either side of the film. Each quarter had connection tabs to allow for independent testing of each segment.

The speaker's four quadrants were connected to a single Trek 2220 high-voltage amplifier, and the speaker was inflated to an approximately hemispherical shape with less than 10 kPa of pressure in order to enhance sound production. An audio file converted to a voltage signal was then supplied to the speaker via the amplifier, and the resulting audio was measured on a Shure SM57 microphone placed 25 cm away from the apex of the speaker membrane. As shown in FIG. 6B, the speaker successfully replicated the input signal at the low frequencies required of a subwoofer. The maximum volume produced by the speaker was 45.6 dB SPL, as measured by Decibel X on an iPhone 13 Pro positioned at the same distance from the speaker, just below the primary SM57 microphone. Some noise from the sub-optimal recording environment was audible. The buzzing in the audio may be attributed to the method of clipping the audio signal when the supplied voltage would have exceeded the maximum voltage output of the amplifier. This may be addressed by adding a limiter or compander.

An MDEA with 60 active layers was also fabricated to showcase the ability of the process to produce actuators with many layers. The MDEA was comprised of 12 individual stacks of seven elastomer and six electrode layers (the outer two elastomer layers were inactive, and only served to encapsulate the electrodes). Each of the elastomer layers was doctor-bladed to a thickness of 70 microns, and stamped with 15 mm diameter circular electrodes. These stacks were punched manually with a 17.5 mm hammer-driven hole punch and stacked atop each other to create the 6.0 mm-tall, 17.5 mm-diameter cylindrical MDEA seen in FIG. 6C. Colloidal graphite paint was used to connect the edges of the electrodes to thin wires, and the contacts were then encapsulated in a small droplet of P7670.

The device was suspended by its connecting wires in a free displacement condition, and its wires were connected to a Trek 2220 amplifier. The amplifier actuated the device with a 200 Hz sinusoidal voltage signal ranging from 0-2 kV. This caused the actuator to reach horizontal strains of 1.24% and vertical strains of 1.23%. Strains were calculated by taking high-speed video with a Phantom V2512 and using edge detection to find the perimeter of the device in each frame.

Design improvements may yield increased strains. Because only five out of seven elastomer layers were active and the electrodes were surrounded by a 1.25 mm margin, only 52% of the actuator's total volume was active.

### Example Conclusion

A high-throughput, large-electrode MDEA fabrication process that works with a wide range of elastomer materials was presented in this Example. This combination of qualities suggests a path to industrial-scale production of MDEAs. The electrodes produced via this process were shown to be stretchable beyond 200%, added negligible stiffness to the soft structure, maintained their strain-resistance behavior over at least 100 cycles, and had breakdown strengths of 33.5 V μm⁻¹. While the electrodes were stretchable beyond 200%, the application is not so limited, and electrodes may be stretchable beyond 100%, beyond 200%, and/or beyond 300%. While breakdown strengths of 33.5 V μm⁻¹ were achieved, the application is not so limited, and a breakdown strength of greater than 20 V μm⁻¹, greater than 30 V μm⁻¹, and greater than 40 V μm⁻¹ may be achieved.

A large-area DEA subwoofer and 60-layer MDEA demonstrated the capabilities achievable with this batch-spray and stamp process.

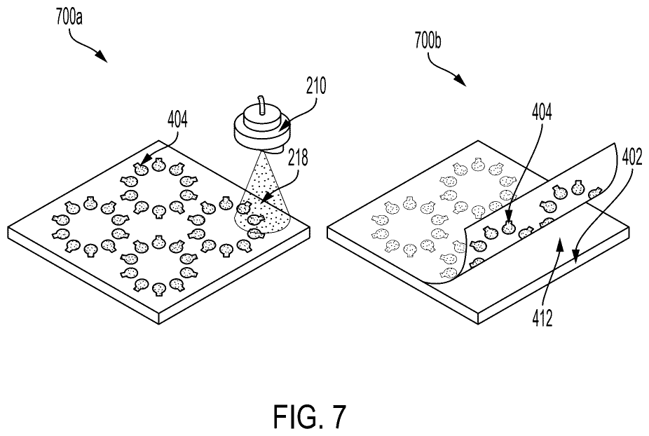

FIG. 7 shows, according to some embodiments, a schematic diagram of an exemplary process comprising: (i) process 700a which may include spraying a conductive material on a plurality of portions of a masked carrier substrate to form a plurality of electrodes; and (ii) process 700b which may include transferring the plurality of electrodes to an elastomer layer.

FIGS. 8A-8D show four steps of an exemplary roll-treatment method, according to some embodiments, which may be included in a process such as that shown in FIG. 7. As shown in FIG. 8A, a magnetic mask 212 can be used to obtain patterned electrodes 404. FIG. 8B shows the magnetic mask 212 being removed, leaving behind the patterned electrodes 404. FIG. 8C shows a film 804 (e.g., sheet of PET 118 shown in FIG. 1A-4) covering the layer of electrodes 404. The film may comprise a polymer (e.g., PET, PVC), a metal, and/or a metal alloy, as the film material is not so limited. In FIG. 8D, a roller 406 is shown applying pressure and may reduce peaks on the electrode surface.

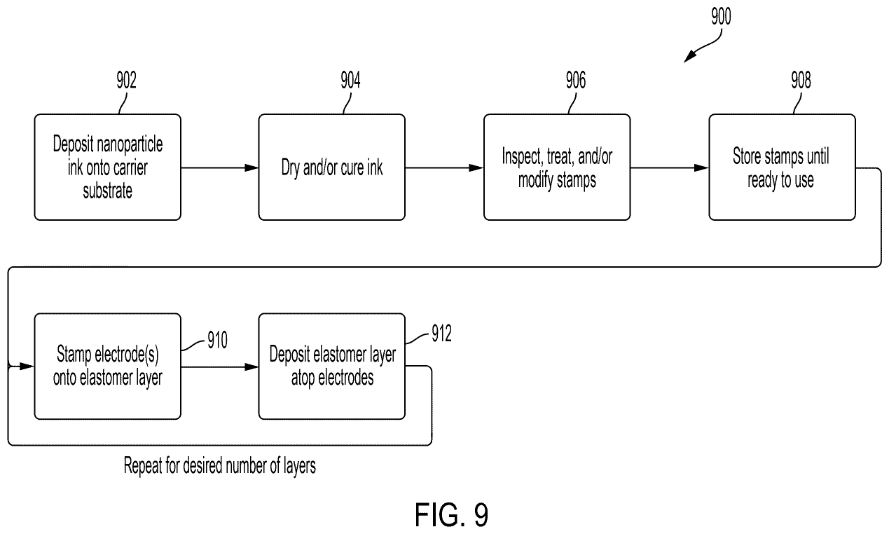

FIG. 9 is a flow chart showing an exemplary process 900 for processing electrode(s) and transferring the electrode(s). At step 902, nanoparticle ink may be deposited onto a carrier substrate (i.e., carrier film 214 shown in FIGS. 2A-2B). At step 904, the ink may be cured or may dry. At step 906, the stamp electrodes may be inspected, treated, and/or modified. As described herein, the inspection may involve performing one or more quality control tests on the one or more electrodes. Furthermore, the treatment may involve a mechanical treatment step and/or a chemical treatment step. The modification may involve generating one or more electronic and/or structural changes in the one or more electrodes.

Referring to FIG. 10, FIG. 10 shows, according to some embodiments, structuring and processing of deposited film(s). Structuring and processing of electrodes or films may alter the transfer properties and therefore allow for the transfer of more delicate structures and/or enhance the transfer process. As shown in FIG. 10, deposited film 1002 may be disposed on substrate 1004 (e.g., but not limited to, carrier film 214 shown in FIG. 2B). External stimuli 1006a may be applied from a side of the substrate 1004. External stimuli 1006b may be applied from a side of the deposited film 1002. As a non-limiting example, external stimuli 1006a may comprise laser energy of a carbon dioxide laser. External stimuli may include a single stimulus or multiple stimuli. External stimuli 1006a and 1006b may be used individually or in combination. External stimuli 1006a and 1006b may include but are not limited to light, temperature, and a combination of light and temperature. Localized heating can be used to change adhesion as well as electric and/or dielectric properties on a substrate and therefore on a target film as well. External stimuli may include mechanical and/or chemical treatments. After application of external stimuli 1006a and/or 1006b, as shown in FIG. 10, structured surface 1008 may result. Structured surface 1008 may include a pattern, such as but not limited to a lattice pattern. Focused light may be used to inscribe a pattern by manipulating at least a section on the substrate. Conventional photolithography and e-beam/thermal evaporator may be used to make an electrode pattern. By manipulating or tailoring the deposited material, the conductivity can be changed, as can the interface and/or adhesion properties.

The external stimuli 1006a and 1006b shown in FIG. 10 may be used as part of a doping step, a modification step, a structuring and processing step, a cleaning step, and/or other processes described herein relating to deposited materials. While both a deposited material and a substrate are shown in FIG. 10, external stimuli may be applied to one of the deposited material and the substrate and/or both. While a deposited film and a substrate are shown in FIG. 10, multiple layers of the deposited film and/or the substrate may be included and subjected to external stimuli.

Returning to FIG. 9, at step 908, the stamps may be stored until ready to use. The electrodes may be from a same carrier substrate or from a different carrier substrate. At step 910, the electrode(s) may be stamped onto an elastomer layer (e.g., as shown in FIGS. 4A-4D) on a first surface. Optionally, the electrode(s) may be stamped onto a second surface of the elastomer layer. At step 912, an elastomer layer is deposited atop the electrode(s). As described herein, elastomer precursor may be deposited and subsequently cured, a non-limiting example of which is shown in FIGS. 1B-1 to 1B-2. Following step 912, as shown in FIG. 9, steps 910 and 912 may be repeated for a desired number of layers. As part of, or following step 912, process 900 may include laminating at least two stacks together to form a DEA. The lamination step may involve the use of external stimuli (i.e., external stimuli 1006b shown in FIG. 10) applied to stacks of electrodes and elastomers.

The process shown in FIG. 9 may be performed manually and/or automatically in whole or in part, and may be embodied as computer readable instructions stored on non-transitory computer readable memory associated with at least one processor such that when executed by the at least one processor, a system may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

### Experimental Methods

### Ink Preparation

The electrode ink was prepared by dispersing Printex CB in IPA at a ratio of 0.125 wt % (0.95 mg/mL). This loading of CB was found to be sufficient to produce a sheet resistance of 11.3 kΩ/sq without using excessive material which would otherwise risk additional defects, stiffness, and material cost.

The mixture was then sonicated in a glass bottle using a QSonica Q500 tip sonicator with a 12.5 mm diameter extended tip at an amplitude of 75% for 10 minutes, yielding an energy density of 420 J/mg of CB. To avoid significant sedimentation of the CB within the solution, a clean magnetic stir bar was placed into the bottle, and the bottle was placed on a magnetic stir plate (e.g., as shown in FIG. 2B). This stir plate kept the solution well-dispersed throughout long sprays.

### Substrate and Mask Preparation

A PTFE carrier film (Goodfellow, FP30-FM-000140) was prepared by laser-cutting alignment holes. These holes allowed for precise alignment of the carrier film and pattern mask during spraying, and the electrode and multilayer substrate during electrode stamping. It was then cleaned with distilled water, IPA, acetone, IPA again, and distilled water again and blown dry to remove any residual contamination.

Electrode patterns and alignment holes can be designed in computer-aided design software and automatically cut out using a vinyl cutter (Cricut Maker). This allows for quick iterations of electrode designs. The mask material was a flexible, 750 μm thick sheet of magnetized iron filings in a vinyl binder matrix (5761K24, McMaster-Carr). It can be reused for multiple batches of electrodes.

The PTFE carrier film was placed onto a steel jig and the magnetic mask was placed atop it. The mask's magnetic attraction to the jig formed a tight seal around the edges of the pattern, ensuring sharp features. This jig assembly was then placed onto a hot plate set to 80° C. (e.g., as shown in FIG. 2A).

### Batch Spraying Procedure

A tube was inserted through the jar's lid, and a peristaltic pump dispensed the ink through this tube at a rate of 0.8 mL/min. An accumulator was connected at a junction in the line to prevent backflow and to smooth flow variations.

The ink then flowed into an atomizing nozzle (Sonaer, NS130K) which broke the stream into micron-scale droplets. These droplets were expelled from the nozzle using a 60 kPa air supply onto the surface of the carrier film, which was mounted 10 cm below the nozzle.

The nozzle was mounted on a custom-built gantry which swept the nozzle back and forth in a raster pattern over the surface of the carrier film (e.g., as shown in FIG. 2A). The sweep was repeated eight times at a feed rate of 2000 mm/min, with 1 cm spacing between raster lines. The full path over a 300×300 mm sheet required approximately 30 minutes to complete. Once the deposition was complete, the carrier film was removed from the heat plate and covered.

Each of these parameters was selected through a preliminary and largely heuristic process and could be further tuned to improve parameters such as deposition speed and electrode quality. The nozzle, for example, can accommodate larger flow rates (e.g., 20 mL/min) that could allow for much faster batch spraying with added optimization.

### Mechanical Treatment

Once the PTFE carrier film had cooled to room temperature, the CB electrode on the carrier film was treated by manually pressing a sheet of 125 μm polyethylene teraphthalate (PET) (Duralar Clear) onto it with a rubber roller with approximately 100 N of force (e.g., as shown in FIG. 8D). An anti-static gun (Milty Zero-stat 3) was used to remove static from the sample's surface, which would otherwise attract dust particles. Once the electrode had been treated, it was covered and stored in an oven set to 70° C. to keep it dry (e.g., as shown in FIG. 1A-5).

### Stamp Transfer Testing

To characterize the transfer of CB electrodes from the PTFE carrier to the elastomers, a batch of 25 circular electrodes with diameters of 20 mm were sprayed and treated using the procedure described above. Sheet resistance was measured while the electrodes were still on the PTFE carrier using a four-point probe connected to a Keithley 6221 current supply and Keithley 2182A nanovoltmeter. In order to avoid edge effects that could affect the measurement of sheet resistance, the 20 mm diameter of the electrodes used for testing sheet resistance was larger than that of the breakdown samples. Lab View software was written to supply current and measure the resulting change in voltage. This was performed at three voltage steps, and a line of best fit was taken to determine the resistance.

Films of various elastomers were produced by spin-coating onto glass or acrylic substrates. They were then allowed to cure, which could include completely curing or partially curing. In the case of VHB 4910, a 1 mm thick tape was adhered to thick 250 μm PET, with no extra curing required. Each of these elastomers was treated with an anti-static gun and placed in a large petri dish to prevent dust from accumulating on the exposed surface.

For each elastomer, three circular electrodes were chosen as transfer samples. These electrodes were transferred to the elastomer surface using a soft roller to apply pressure.

Immediately after transfer, the sheet resistance was measured with the four-point probe.

### Breakdown Testing

Breakdown tests were performed on single-layer DEAs 15 mm in diameter. The elastomer layer was produced by spin-coating the uncured P7670 precursor onto a circular acrylic substrate at 1500 RPM for 60 seconds. This yielded a layer thickness of 32.7±0.7 μm. The precursor was then degassed in a vacuum chamber at room temperature for approximately four minutes and cured in an oven at 70° C. for approximately four minutes under normal atmosphere. Once removed from the oven, batch-sprayed 15 mm diameter circular CB electrodes were stamp-transferred onto the P7670. This was repeated once to form the DEA structure and then a final spin coating step was used to encapsulate the parallel electrodes. The encapsulation reproduced the conditions of an MDEA structure.

The design was electrically connected by cutting through the thickness of the devices and applying colloidal graphite paint (Ted Pella, 16053) to the exposed cross-sections. The paint was then extended to copper tape contacts which were attached to the leads of a Trek 610 E high voltage amplifier.

Breakdown tests were performed by applying a linear voltage ramp of 10 V/s up to 2 kV with the current limit set to 30 μA. The current was monitored and the test was terminated once the operator noticed a sustained surge in current. The breakdown strength was defined as the highest voltage at which the current through the capacitor was below 1 μA for at least 0.25 seconds. This accounts for transient current spikes which occur prior to a catastrophic breakdown of the device.

### Resistance Strain Testing

Samples were prepared by patterning dogbone-shaped electrodes whose central beams were 25×10 mm. Four of these were stamped onto successive doctor-bladed elastomer layers, each 30 μm thick. These samples were then cut out with a stencil to yield a rectangular sample 40×25 mm. Sections of the elastomer without any CB on it were similarly cut out to yield the elastomer-only samples, which controlled for any change in stiffness due to the successive deposition and curing processes. The rectangular CB composites were then sliced such that the ends of the embedded electrodes were exposed. As with the breakdown samples, Pelco colloidal graphite paint was used to connect the electrodes to copper leads, to which the LCR meter's leads were attached.

For the resistance-strain characterization, an Instron tensile testing machine (5544A) equipped with a 10N load cell was used to apply strains. All experiments were performed with a strain rate of 1 %/s. The electrode resistance was continuously measured with an LCR meter (Keysight E4980A) used in the CsRs mode at a frequency of 100 Hz with a 2V medium average. To allow a synchronous recording of force, strain, and resistance, a LabVIEW program was designed to connect the LCR meter with the control software of the Instron tensile tester (Bluehill V4.29).

While each of the curves in FIGS. 5A-5D plots the results from a single representative sample, three elastomer-only and three CB-Elastomer composite samples were tested. The rupture experiments were performed after first applying the 100 cycles of loading, as shown in FIG. 5A.

### MDEA Strain Measurement

A Phantom v2512 recorded the actuation of the experimental MDEA device at 4000 fps with 1080p resolution. A custom Matlab image analysis program imported each frame and, using Canny edge detection, identified the edges of the image. Exterior edges were identified as those that were the maximum or minimum edge pixel in a given row or column. The average distance between these exterior edges was used to measure strain in each direction relative to the distance in a resting frame. To account for transient, erroneous detections of edges, outliers were removed from distance measurements before the average was calculated.

### Elastomer Layer Thickness Measurements

Breakdown sample layer thicknesses were determined by cutting through the multilayer structure and imaging the cross-section on an Olympus OLS4000 laser microscope. Measurements were made in the accompanying Olympus software by measuring the distance between manually-placed reference lines on the electrodes that bound the central elastomer layer. One image each was taken from three breakdown specimens.

### Conclusion

As discussed, some aspects may be embodied as one or more methods including, but not limited to, any method including steps described with reference to at least illustrative processes 700a, 700b, and 900 and FIGS. 1A-1 to 1C-3, 4A-4E, 7, 8A-8D, and 9. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Devices of the types described herein may be used in various settings including but not limited to the fields of soft optics, soft stretchable electronics, and flexible electronics, such as organic solar cells, TFTs, haptics, sensors and energy harvesting systems, solar cells, LEDs, diodes, and medical imaging.

Devices of the types described herein with stacked structures may be used for complementary metal-oxide-semiconductor (CMOS) circuits on flexible, stretchable substrates.

Devices of the types described herein may also be used as soft sensors for small, medium, to large scale soft transducer technologies, including but not limited to DEAs, dielectric elastomer sensors (DESs), and dielectric elastomer generators (DEGs).

As non-limiting examples, devices of the types described herein may be used for human machine interfaces and wearable devices, as well as soft sensors for large-scale monitoring of civil structures, such as that described in U.S. Pat. No. 8,384,398, entitled “Structural Health Monitoring System and Method Using Soft Capacitive Sensing Materials” and issued Feb. 26, 2013, which is herein incorporated by reference in its entirety. As additional non-limiting examples, devices of the types described herein may be used for soft sensor surfaces with functionalized surfaces, soft voltage tunable devices for human machine interfaces, energy harvesting, such as but not limited to ocean energy harvesting, as well as soft optics systems, such as those described in German Patent No. 102016121792, filed Nov. 14, 2016, which is herein incorporated by reference in its entirety.

The aspects of the technology described above may provide various benefits. Some non-limiting examples of benefits are now described. It should be appreciated that not all embodiments provide all benefits, and that benefits other than those listed may be realized in at least some embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately,” “substantially,” and “about” may be used to mean ±20% of a target value in some embodiments, within ±10% of a target value in some embodiments, within ±5% of a target value in some embodiments, and yet within ±2% of a target value in some embodiments. The terms “approximately,” “substantially,” and “about” may include the target value.

What is claimed is:

1. A method of forming a dielectric elastomer actuator, comprising:
depositing a conductive material on at least a first portion of a first carrier substrate to form a plurality of electrodes comprising a first electrode; and
transferring at least a portion of the first electrode to a first surface of a first elastomer layer to form a first electrode layer on the first elastomer layer.

2. The method according to claim 1, wherein the depositing the conductive material comprises depositing the conductive material on a plurality of portions of a first carrier substrate to form the plurality of electrodes.

3. The method according to claim 2, wherein the plurality of portions are arranged in a pattern.

4. The method according to claim 3, further comprising positioning or depositing a mask comprising a plurality of patterned openings on the first carrier substrate prior to the depositing step.

5. The method according to any one of claims 2-4, further comprising:
depositing a second elastomer layer on the first electrode layer; and
transferring at least a portion of a second electrode of the plurality of electrodes from the first carrier substrate to the second elastomer layer to form a second electrode layer on the second elastomer layer,
wherein the dielectric elastomer actuator comprises the first electrode layer, the second elastomer layer, and the second electrode layer.

6. The method according to any preceding claim, wherein the depositing the conductive material comprises depositing the conductive material on the first portion of the first carrier substrate to form the first electrode and depositing the conductive material on a first portion of a second carrier substrate to form a second electrode.

7. The method according to claim 6, further comprising:
depositing a second elastomer layer on the first electrode layer; and
transferring at least a portion of a second electrode from the second carrier substrate to the second elastomer layer to form a second electrode layer on the second elastomer layer,
wherein the dielectric elastomer actuator comprises the first electrode layer, the second elastomer layer, and the second electrode layer.

8. The method according to any preceding claim, further comprising transferring at least a portion of the second electrode to a second surface of the first elastomer layer to form a second electrode layer on the first elastomer layer.

9. The method according to any preceding claim, wherein the dielectric elastomer actuator comprises at least 5, at least 10, at least 20, at least 60, at least 100, at least 500, at least 1000, at least 5000, or at least 10,000 pairs of electrode layers and elastomer layers.

10. The method according to any preceding claim, wherein the first electrode layer has an area of at least 62,500 mm² , at least 90,000 mm² , at least 160,000 mm² , at least 250,000 mm² , at least 360,000 mm² , at least 490,000 mm² , at least 640,000 mm² , at least 810,000 mm² , or at least 1,000,000 mm².

11. The method according to any preceding claim, wherein the depositing the conductive material is performed by spraying, ink jetting, stamping, doctor blading, electric spraying, screen printing, Langmuir-Blodgett deposition, vacuum filtration, chemical vapor deposition, and/or physical vapor deposition.

12. The method according to any preceding claim, wherein the transferring at least a portion of the first electrode to the first elastomer layer comprises applying pressure to the first carrier substrate such that the first elastomer layer is in physical contact with the first electrode.

13. The method according to claim 12, wherein the applying pressure to the first carrier substrate is performed using a roller and/or a press.

14. The method according to any preceding claim, wherein depositing the second elastomer layer comprises depositing an elastomer precursor on the first electrode layer using spin coating, spray depositing, doctor blading, and/or dry-film stacking.

15. The method according to claim 14, wherein depositing the second elastomer layer comprises curing the elastomer precursor to form the second elastomer layer.

16. The method according to any preceding claim, further comprising removing the carrier substrate from the first elastomer layer after transferring at least a portion of the first electrode to the first surface of the first elastomer layer.

17. The method according to any preceding claim, further comprising, after the depositing the conductive material and before the transferring at least a portion of the first electrode, applying a modification step.

18. The method according to claim 17, wherein the modification step comprises a mechanical treatment step.

19. The method according to claim 18, wherein the mechanical treatment step comprises applying a pressure to at least a portion of the first electrode.

20. The method according to claim 19, wherein the applying pressure to at least a portion of the first electrode is performed using a roller and/or a press.

21. The method according to claim 17, wherein the modification step comprises a chemical treatment step.

22. The method according to any preceding claim, wherein after the modification step, the first electrode has an average surface roughness of about 5 μm or less.

23. The method according to any preceding claim, wherein the conductive material comprises a carbon-containing conductive material, a metal-containing conductive material, a metal alloy, a conductive polymer, and/or any combination thereof.

24. The method according to any preceding claim, wherein the carbon-containing conductive material comprises carbon black, graphite, and/or carbon nanotubes.

25. The method according to any preceding claim, wherein the metal-containing conductive material comprises silver nanowires and/or gold nanoparticles.

26. The method according to any preceding claim, wherein the first carrier substrate comprises a polymer.

27. The method according to any preceding claim, wherein the first carrier substrate comprises a metal-containing conductive material, a metal alloy, a carbon-containing conductive material, and/or a conductive polymer.

28. The method according to any preceding claim, wherein at least a portion of the first carrier substrate comprises a plurality of pores.

29. The method according to any preceding claim, further comprising applying an anti-static treatment to the first electrode.

30. A method of forming a multilayer dielectric elastomer actuator, comprising:
depositing a conductive material on a plurality of portions of one or more carrier substrates to form a plurality of electrodes;
transferring the conductive material from at least two electrodes of the plurality of electrodes to a plurality of elastomer layers to form a plurality of stacks; and
laminating at least two stacks of the plurality of stacks together to form the multilayer dielectric elastomer actuator.

31. The method according to any other preceding claim, further comprising, applying a cleaning step after the depositing the conductive material.

32. The method according to any preceding claim, further comprising, processing the conductive material, wherein the processed conductive material comprises a structured surface.
